(19) United States
(12) Patent Application Publication
(10) Pub. No.: US 2007/0231106 A1
(43) Pub. Date: Oct. 4, 2007

(54) Unknown

(75) Inventor: William Arliss Walker, Butler, OH (US)

Correspondence Address: RONALD J. KOCH, 4200 REGENT ST., SUITE 200, COLUMBUS, OH, 43219, US

(73) Assignee: CHRISTOPHER J. GRANT

(21) Appl. No.: 11/395,659

(22) Filed: Apr. 3, 2006

(51) Int. Cl. F16B 35/06

(52) U.S. Cl. 411/401

(57) ABSTRACT

The present invention is an anchoring device used in securing an attachment to an object or structure that has no attachable surface wherein this tool can be attached to said object to be lifted or pulled. This tool is made of a machined two-inch solid steel round stock, three feet long utilizing very aggressive No#4 thread lead by a 1½drill with a conical relief to avoid binding. By the use of aggressive screw threads on a very tough steel shaft and having the ability to use several different drill heads for penetration of objects thereby allowing the tool to lock or attach it self to the object. A winch and/or pulling devices can then connected to the tool pull ring and the object is pulled out or removed from the ground, water or both. The removal of this tool from an object is accomplished by turning the tool counter clockwise or until it is completely unscrewed.

### BACKGROUND OF THE INVENTION

Since the first inception of power and telephone poles very little innovation or new technologies have been introduced to remove these units once decayed or broken off due to hurricanes, accidents and/or other out side forces.

I have been a lineman for thirty years and have struggled to remove countless power poles. Many times having to excavate around these poles in order to use a choker chain or the massive hydraulic pole jack. While these devises do have their functions they also have their shortcomings, slipping off or just pushing the pole to the side. This can be very dangerous, time consuming and expensive for the company.

I have developed this tool having safety first in mind. The tool has been designed for, but not limited to the removal of power poles broken off at ground level due to auto accidents, flooding, Storms and/or deterioration. Since this tools inception, my crew and I have successfully removed numerous power poles in a negligible time without incident.

This tool adapts to the Kelly bar on all line trucks enabling the lineman to drill into a pole, post, stump, etc, thereby anchoring the tool head into whatever item is to be removed. The lineman can then attach the pull ring to the tool and securely winch the pole being 18″ to 36″ in diameter out of the ground. Some of the larger poles may require a relief hole excavated next to it to relieve pressure and/or suction. However In most cases, this has been a one-man operation saving the company time and money while providing safety for the lineman.

To remove this tool, insert a spanner bar through the pull ring and unscrew, usually one to two turns counter clockwise and the tool will back out by hand.

### SUMMARY OF THE INVENTION

The essence of the instant invention is the use of aggressive screw threads on a very tough steel shaft and having the ability to use several different drill heads for penetration of objects being removed. Said attachment can then connected to the hydraulic drive by use of a Kelly Bar adapter powering and/or drilling this tool into items of removal whereby using the threads locking said tool head into a pole, tree, post, etc attaching it self in the object. With said tool having a conical relief to help prevent binding, burning and making for easier removal. The tool is then disconnected from the hydraulic drive and the tool pull ring is attached to the tool by a pin and snap ring. A hydraulic winch is connected to the tool pull ring and the object is then pulled out or removed from the ground or water. The removal of this tool from an object is accomplished by turning the tool counter clockwise or until it is completely unscrewed.

### BRIEF DESCRIPTION OF THE DRAWINGS

FIG. 1 is an exploded view of the invention shown with the complete tool, Kelly bar adapter; pull ring, drill bit, and pin in accordance with the invention.

FIG. 2 is side view of the invention shown installed with the Kelly bar adapter and tool assembly

FIG. 3 is side view of the invention shown installed with the pull ring and tool assembly

FIG. 4 is side view of the invention shown as inters changeable assemblies

FIG. 5 is side view of the invention shown as engineered drawings of the complete tool assembly.

### DESCRIPTION OF THE PREFERRED EMBODIMENT

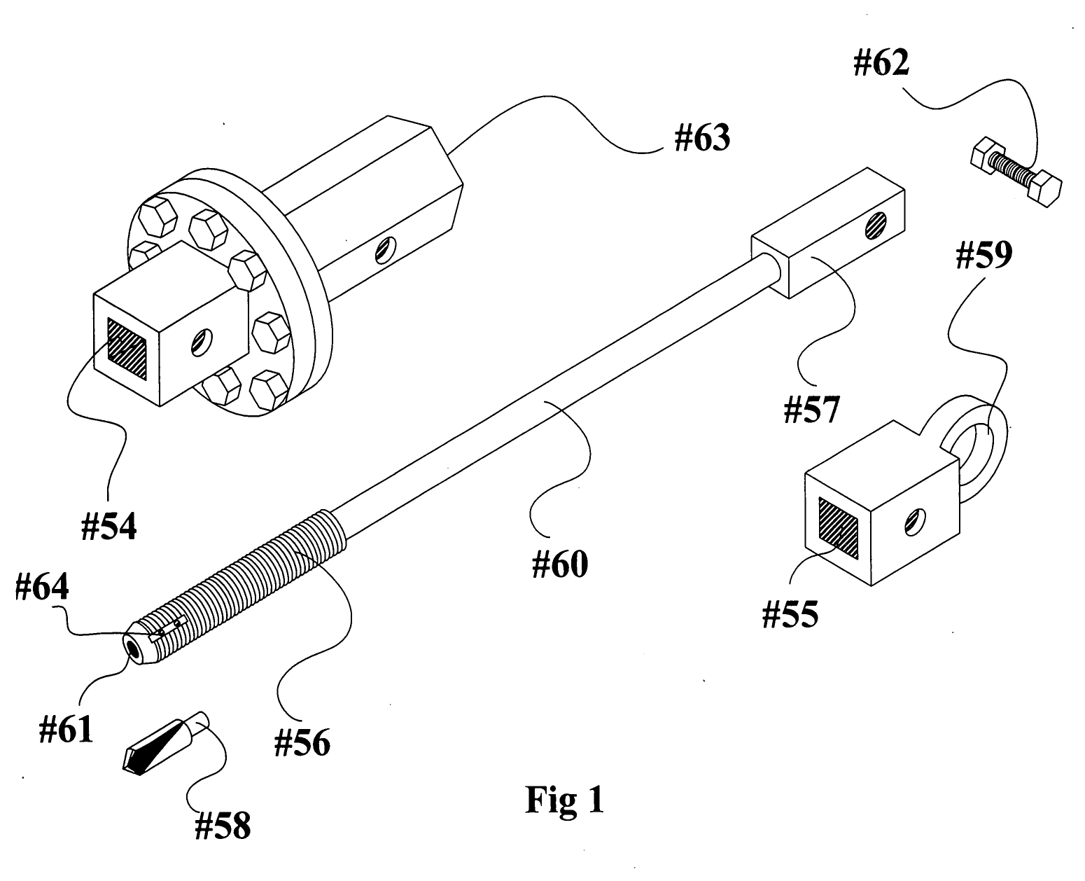

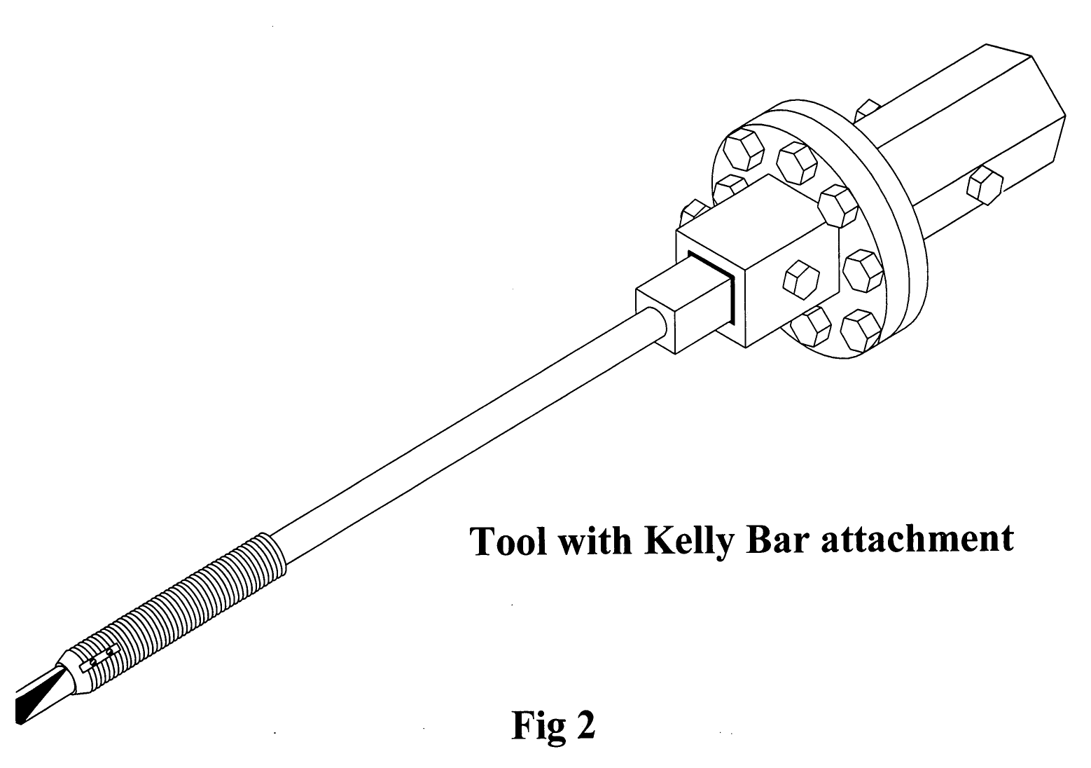

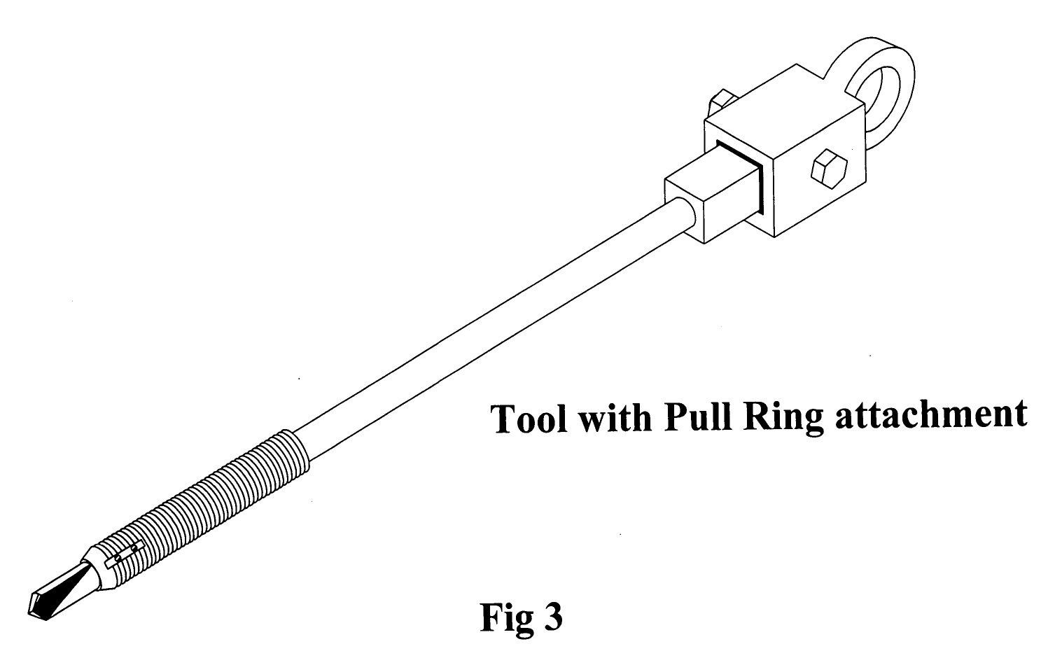

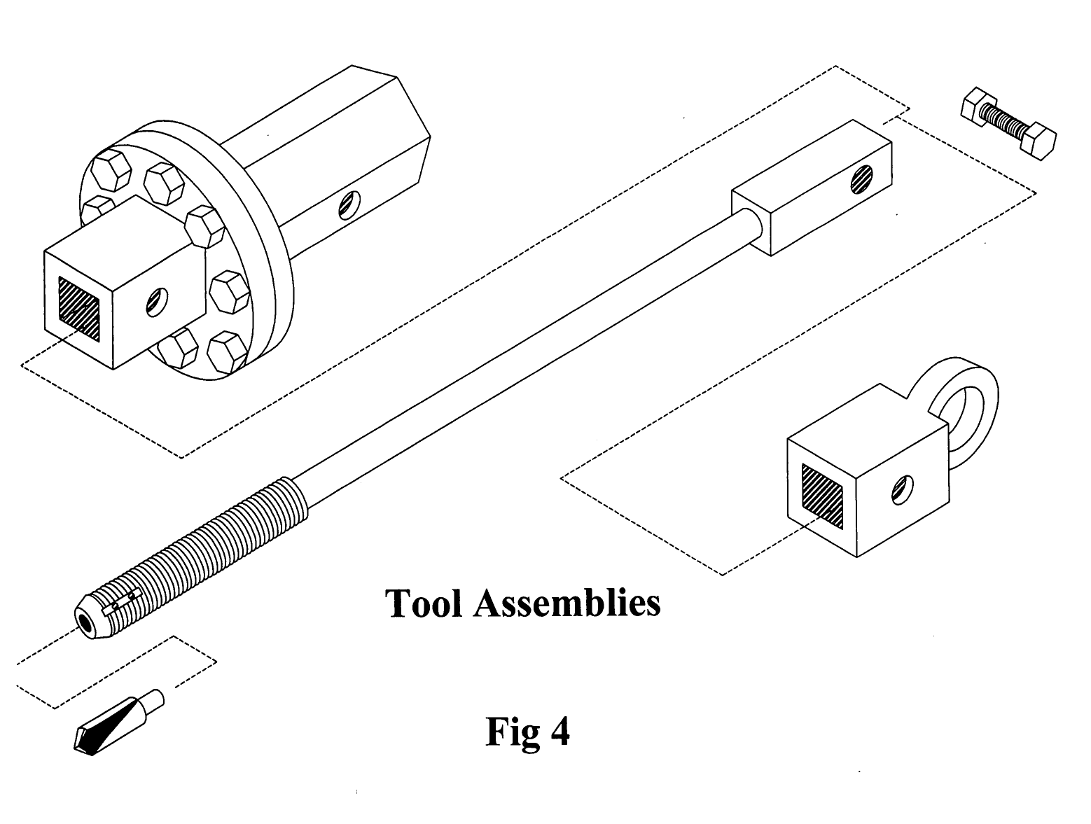

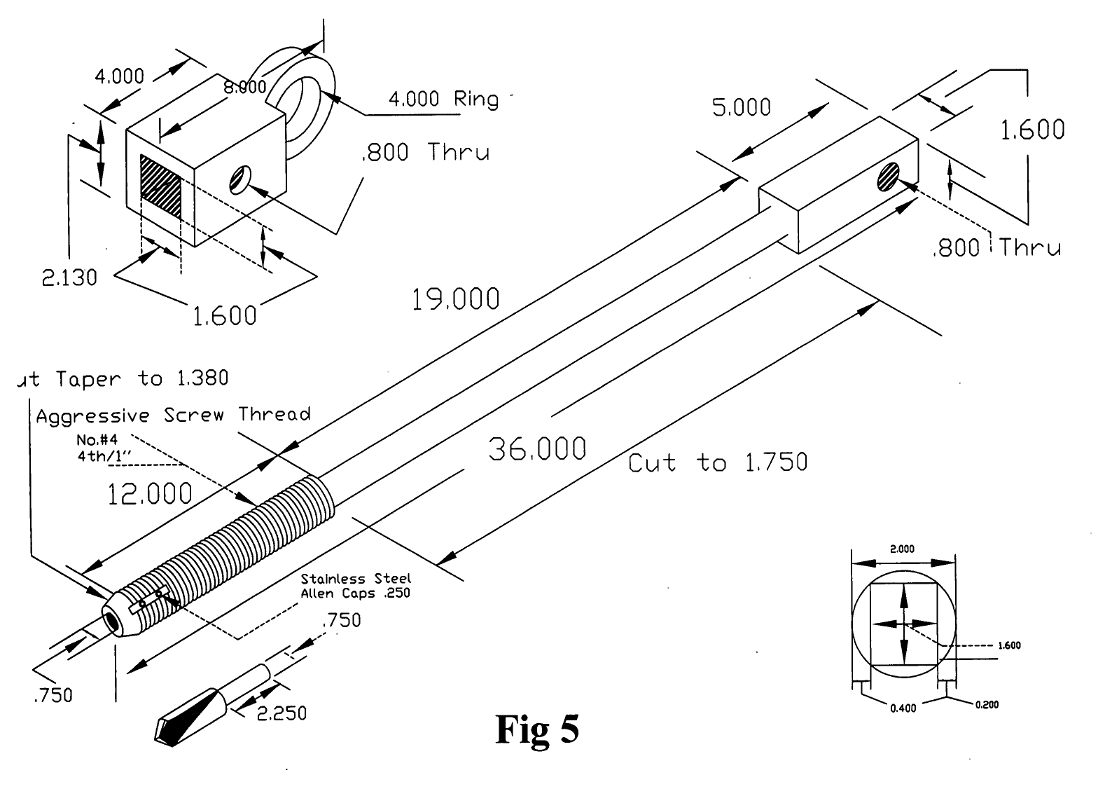

Referring now to the drawings, wherein like numerals designate like and corresponding parts throughout the several views, FIG. 1 numeral 60 generally designates the main tool body of the invention. In FIG. 1 the component parts of the tool assembly are shown in an exploded view with the entire tool body assembly designated by numerals 56,57,60,61, 64. FIG. 1 numeral 60 is made of two-inch solid steel round stock, three feet long and having a very aggressive No#4 thread extending one foot from the bottom of the shaft. FIG. 1 numeral 56 this is lead by a 1½″ drill FIG. 1 numeral 58 and having a conical relief FIG. 1 numeral 61 to avoid binding and held in place by stainless steel Allen sets FIG. 1 numeral 64. FIG. 1 numeral 57 having a squared head measuring 1.600″×1.600″ and 5.000″ long and having been machined to fit the Kelly bar adapter as shown FIG. 1 numeral 54. And FIG. 2. FIG. 1 numeral 57 having a 0.800″ hole through both the Kelly bar adapter FIG. 1 numeral 63 and the tool FIG. 1 numeral 60 to be held together by a pin and/or bolt for the primary use of drilling FIG. 1 numeral 62. FIG. 1 numeral 55 and 59 pull ring attachment connects to FIG. 1 numeral 57 with the tool to be held together by a pin and/or bolt for the primary use of pulling as seen in FIG. 3. FIG. 4 all assemblies are shown in proper perspective in FIG. 5 designates the complete essence of the invention having all component parts of the tool assembly shown in an exploded view of engineered drawings and specifications

While the above description constitutes preferred embodiments of the present invention, it will be appreciated that the invention is susceptible to modification, variation, and change without departing from the proper scope and fair meaning of the accompanying claims.

### Description of Art

This rugged tool is made of two-inch solid steel round stock, three feet long and having a very aggressive No#4 thread. This is lead by a 1½″ drill with a conical relief to avoid binding. This steel has been Proof tested, magnetic particle inspected from 8000 to 44,000 lbs load capacity and rated at 5:1 Safety factor. I have a working proto type at present. (Photos and Cad Drawings enclosed)

1. A tool having external threads whereby drilling into attaching and securing a pulling apparatus to an object with said device. Comprising of a drill head followed by one foot of threaded shaft used in securing said object to be lifted and having a machined top to fit the Kelly bar adapter enabling the insertion of said tool whereby having a pull ring attachment allowing for a cable and/or chain connection.

2. A locking device for securing winch and cable and/or pulling device directly to poles, Post, trees, or concrete structures

3. A tool having several attachments for removal and/or lifting of objects
